(19) United States
(12) Patent Application Publication
(10) Pub. No.: US 2024/0124325 A1
(43) Pub. Date: Apr. 18, 2024

(54) ENHANCED MICROPLASTIC REMOVAL

(71) Applicant: X Development LLC, Mountain View, CA (US)

(72) Inventors: Thomas Robert Swanson, Sunnyvale, CA (US); Harrison Pham, Sunnyvale, CA (US); Grace Calvert Young, Mountain View, CA (US); Mandy Jubang, Santa Clara, CA (US); Diosdado Rey Banatao, Los Altos Hills, CA (US)

(21) Appl. No.: 18/239,697

(22) Filed: Aug. 29, 2023

Related U.S. Application Data
(60) Provisional application No. 63/420,472, filed on Oct. 28, 2022.
(60) Provisional application No. 63/379,594, filed on Oct. 14, 2022.

(51) Int. Cl. C02F 1/00; C02F 1/36; G06V 10/143; G06V 20/05

(52) U.S. Cl. CPC C02F 1/008; C02F 1/36; G06V 10/143; G06V 20/05; C02F 2101/30

(57) ABSTRACT

Methods, systems, and apparatus, including computer programs encoded on computer-storage media, for microplastic removal. In some implementations, a method can include controlling a camera to capture one or more images of plastic in water; providing the one or more images to a machine learning model trained to detect plastic; obtaining output from the machine learning model indicating one or more items of plastic; and controlling one or more acoustic transducers to move the one or more items of plastic.

### CROSS-REFERENCE TO RELATED APPLICATION

This application claims the benefit of U.S. Provisional Application No. 63/420,472, filed Oct. 28, 2022 and U.S. Provisional Application No. 63/379,594, filed Oct. 14, 2022 the contents of which are incorporated by reference herein.

### TECHNICAL FIELD

This specification relates to the removal of pollutants from aquatic environments.

### BACKGROUND

Microplastics are tiny plastic particles that result from both commercial product development and the breakdown of larger plastics. As a pollutant, microplastics can be harmful to the environment and animal health. For example, plastic pollution can harm fish if they inadvertently ingest plastics which can clog their digestive tracts and may cause hormonal disruptions.

### SUMMARY

In general, innovative aspects of the subject matter described in this specification relate to a microplastics removal system. For example, microplastics can be removed from a water source using acoustic transducers, a lighting system, and a camera system. The acoustic transducers, lighting system, and camera system can be positioned along a pipe carrying water to or from a water source. In some implementations, water that has been purified by removal of microplastics is transferred back to a water source. In some implementations, microplastics that have been removed from water are transferred to a processing system to, e.g., recycle the microplastics, dispose of the microplastics, among others.

In some implementations, one or more machine learning models are used to remove microplastics. For example, a first machine learning model can be used to detect microplastics in images obtained by a camera system. The first machine learning model can detect a size or type of microplastic and provide data to one or more other systems, such as a system for controlling the acoustic transducers. A second machine learning model can be used to adjust the vibrations of one or more acoustic transducers. In some implementations, the second machine learning model is trained using images of microplastics being removed or images of microplastics not being removed from water.

Advantageous implementations can include one or more of the following features. For example, compared to other potential plastic removal systems, the system described can improve throughput for plastic processing as only a portion of a main water column need be sent through a discharge side tube. With a different filter system, all water can pass through a filter. More fine filters generally have lower throughput capacities compared to less fine filters. By splitting a water column such that only a portion is sent to a filter, a system can either increase throughput over a corresponding system that sends all water through the same filter, or can increase purity by using a more fine filter.

This can reduce strain and likelihood of clogging or damage for any subsequent system for filtering the water that includes the removed microplastics. In general, the described systems and methods can process a higher volume of water compared to traditional filtering systems. By processing a higher volume of water, described systems and methods can help reduce the significant climate change caused by microplastics (e.g., air borne microplastics that reflect the sun's radiation and increase the greenhouse effect). In general, systems described as removing microplastics from water can be used to remove microplastics from the air, where the medium in which the microplastics flow is changed but the processes of identification and removal remain similar.

Plastic pollution can degrade into microplastics. Using conventional filtration methods, small pieces of plastic can be too small to separate from water without harming organisms living in the water. Conventional water filtration practices, such as filtration in water treatment plants for sanitation or drinking water, may remove all organisms including healthy nutrients from the water. The proposed removal systems and methods of microplastics allow for microplastics to be removed from water without removing beneficial components from water, such as minerals, micronutrients, and microorganisms such as algae, plankton, and other organisms.

In some implementations, systems and methods described enable targeted filtering. For example, a given system can be configured to send microplastics to a filtration system and larger or non-plastic objects back to a water source to avoid clogging or contaminating filters. A given system as described can further support any number of post-processing steps, such as filtering, settlement tanks, recycling, among others. The lack of filters on a main column of water helps to prevent jams or clogs that can decrease reliability and throughput of other filter-based systems.

In some implementations, the microplastics are exposed to high energy, e.g., a laser. For example, described systems and methods can direct microplastics to be targeted and destroyed using concentrated laser power. In some implementations, microplastics are decomposed using biological means. For example, described systems and methods can direct microplastics to a removal system that uses bacteria or other cellular organisms to decompose microplastics into less harmful byproducts.

In some implementations, a microplastics removal system includes a self-calibrating device that is used for sonic (e.g., vibrations generated by an acoustic transducer) removal of plastics such as microplastics. Plastics may be removed from water using sonic signals, such as ultrasonic signals. For example, sonic signals may be used to generate cavitation bubbles that form around plastic to direct the plastic towards a filter or a specific filter or one or more filters for determined types of plastics based on a microplastics removal system determining a given type of plastic.

Sonic signals, even without cavitation bubbles, may be generated to collide with plastic particles to move the plastic particles to one or more filtering or removal stages. Additionally, sonic signals may break up plastic particles or otherwise destroy the particles.

Because sonic signals could potentially damage marine life, the techniques described in this specification may specifically focus energy on plastic particles instead of marine life, e.g., fish, coral, sea grass, among others. Because targeting of sonic signals may be difficult, as sonic signals can propagate differently in water based on many factors such as water temperature, water pressure, water chemistry, concentration of fish mucus, and concentration of excrement, repeated self-calibration by a device of a microplastics removal system may enable more accurate targeting and removal. For example, temperature changes alone may cause sonic signals to converge at locations that are centimeters apart and a plastic particle may only be millimeters long, so repeated self-calibration may allow the device of a microplastics removal system to determine different sonic signals that converge at a particular location that may be most effective for plastic removal as temperatures, or other parameters, change.

To account for changes in propagation, a microplastics removal system may use one or more self-calibrating acoustic transducers. A microplastics removal system may include many transducers distributed throughout a removal system. The removal system may continually perform self-calibration to determine propagation parameters that take into account how sonic signals propagate through water within the removal system, e.g., when plastic is removed. When the removal system detects plastic, the removal system may use the propagation parameters to generate sonic signals that focus energy at or near one or more pieces of plastic. The sonic vibrations generated using the propagation parameters can cause one or more items of plastic to be moved into a location for removal or filtering.

In general, one aspect of the subject matter described in this specification can be embodied in methods that include the actions of obtaining one or more images of plastic in water; providing the one or more images to a machine learning model trained to detect plastic; obtaining output from the machine learning model indicating one or more items of plastic; and controlling one or more acoustic transducers to move the one or more items of plastic using the output from the machine learning model.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations, the output from the machine learning model includes a location of each of the one or more items of plastic. In some implementations, the output from the machine learning model includes a value indicating a quantity of the one or more items of plastic. In some implementations, actions include providing data representing the one or more images of plastic in water as input data to control one or more plastic processing stages. In some implementations, actions include controlling the one or more acoustic transducers to move the one or more items of plastic to one or more plastic processing stages configured to process plastic.

In some implementations, the one or more acoustic transducers are configured along a system connected to a water source. In some implementations, actions include controlling a first light of a first color to illuminate; controlling a camera to capture a first image of the one or more images while the first light is illuminated; controlling a second light of a second color to illuminate; and controlling the camera to capture a second image of the one or more images while the second light is illuminated.

In some implementations, actions include controlling the one or more acoustic transducers to move the one or more items of plastic within a vessel, wherein the vessel is connected to a water source at a first location and a second location and the vessel is configured to obtain the water that includes the one or more items of plastic from the first location and provide the water without the one or more items of plastic to the second location. In some implementations, the first location and the second location are the same location. In some implementations, the vessel is within the water source.

In some implementations, obtaining the one or more images of plastic in water includes controlling a camera to capture the one or more images of plastic. In some implementations, actions include detecting a first type of plastic using the one or more images of plastic in water; detecting a second type of plastic using the one or more images of plastic in water; controlling the one or more acoustic transducers to move one or more items of the first type of plastic to a first location; and controlling the one or more acoustic transducers to move one or more items of the second type of plastic to a second location.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for removing microplastics.

FIG. 2 is a flow diagram illustrating an example of a process for removing microplastics.

FIG. 3 is a diagram showing computing devices for removing microplastics.

Like reference numbers and designations in the various drawings indicate like elements.

### DETAILED DESCRIPTION

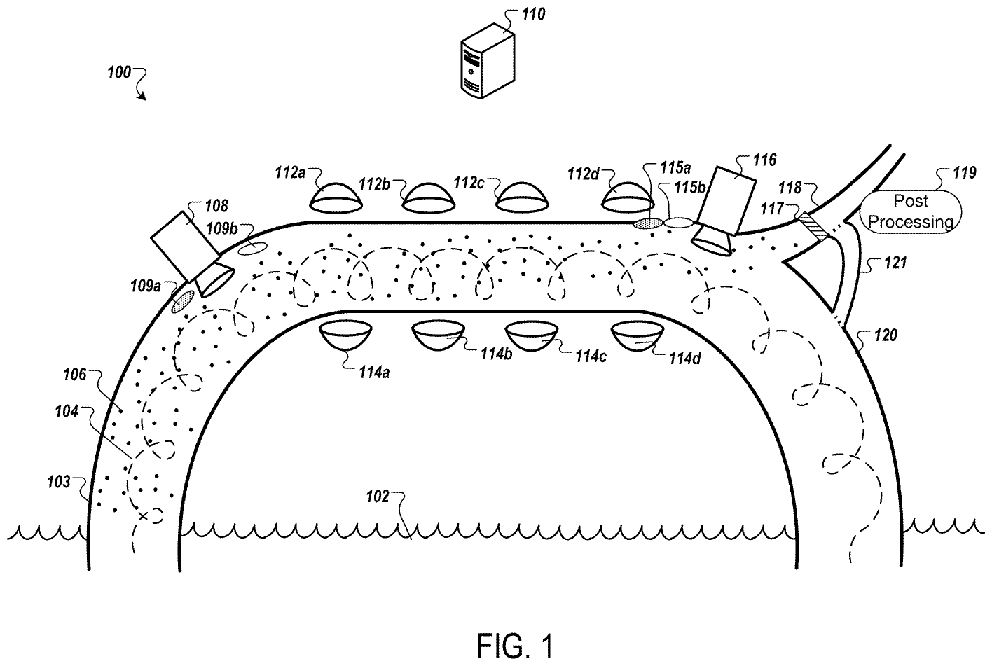

FIG. 1 is a diagram showing an example of a system 100 for removing microplastics. The system 100 includes a camera system, including cameras 108 and 116, a lighting system, including lights 109a-b and 115a-b, a physical removal system, including acoustic transducers 112a-d and 114a-d, and a control unit 110.

Water 104 from water source 102 is moved to pipe 103. The water 104 includes microplastics (e.g., microplastic 106). The system 100 removes the microplastics from the water 104. In some implementations, the physical removal system of the system 100 removes microplastic particles from the water 104 using pressure waves generated by one or more acoustic transducers. For example, the acoustic transducers 112a-d and 114a-d can generate waves of pressure that move microplastics in the water 104 to a discharge tube 118.

In some implementations, a pump is used to move the water 104 from the water source 102 into the pipe 103. In some implementations, natural currents are used to move the water 104 from the water source 102 into the pipe 103. The water source 102 can be a river, storm sewer discharge, ocean, among others.

The water 104 travels through the pipe 103 from the first camera 108 to the second camera 116. The lights 109a-b illuminate the water 104. In general, the lights 109a-b can be calibrated to highlight microplastics in the water 104. In some implementations, the lights 109a-b illuminate different colors. For example, the light 109a can illuminate light in the red visible light spectrum and the light 109b can illuminate light in the blue visible light spectrum. In some implementations, the lights 109a-b emit light of the same color.

In some implementations, the lights 109a-b alternately emit light. For example, the lights 109a-b can be communicably connected or both connected to a controller. The lights 109a-b can alternately emit light, e.g., the light 109a can emit light with a first frequency for a first period of time and after the first period of time the light 109a can stop emitting and the light 109b can emit light in a second frequency. The first and second frequency can be the same or different. The first and second frequencies can represent a range of frequencies emitted by the lights 109a-b.

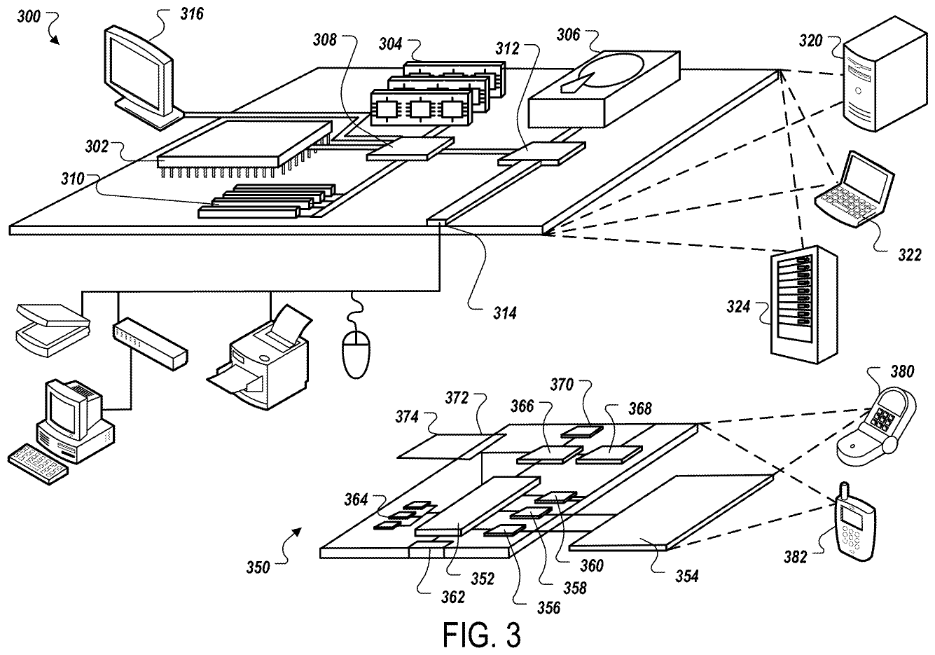

The camera 108 captures one or more images when the water 104, and one or more microplastic particles in the water 104, are illuminated. The camera 108 provides the one or more images to the control unit 110. The control unit 110 includes one or more processing components, e.g., as discussed in reference to FIG. 3. Images captured with different colored illuminated lights can provide more contrast compared to images captured with the same colored illuminated lights based, e.g., on the different ways particles, such as microplastics, scatter different frequency light. In some implementations, the control unit 110 uses a difference between two or more images captured by the camera 108 to detect one or more microplastic particles.

In some implementations, the control unit 110 uses a trained machine learning model to detect microplastic particles in the water 104. For example, a trained machine learning model can detect different shapes and sizes of microplastics. The control unit 101 can provide one or more images obtained from the camera 108 to a trained machine learning model. The control unit 101 can obtain output from the trained machine learning model indicating one or more microplastic particles detected in the water 104.

In some implementations, the control unit 110 provides one or more control signals to removal devices using a detection of one or more microplastic particles. For example, if the control unit 110 detects no microplastics in the water 104, the control unit 110 can not provide instructions for the acoustic transducers 112a-d and 114a-d or can provide instructions for the acoustic transducers 112a-d and 114a-d not to generate pressure waves. If the control unit 110 detects microplastics in the water 104, the control unit 110 can provide instructions configured to cause the acoustic transducers 112a-d and 114a-d to generate pressure waves.

In some implementations, the type or size of microplastic detected affects a control signal provided by the control unit 110. For example, for larger microplastic particles or more rigid particles, the control signal can provide control signals to one or more acoustic transducers (e.g., the acoustic transducers 112a-d or 114a-d) to use fewer or less powerful pressure waves compared to smaller or less rigid particles. In some implementations, the control unit 110 detects other types or sizes of microplastic, or the same types or sizes of microplastics, and provides different or the same instructions to one or more removal devices, such as the acoustic transducers 112a-d or 114a-d.

In some implementations, an environment condition affects a control signal provided by the control unit 110. For example, the control unit 110 can detect a salinity of water, a number of non-microplastic particulates, density, among others, e.g., using one or more connected sensors. The control unit 110 can generate one or more control signals to account for the environmental conditions. In some implementations, the control unit 110 uses input from the camera 116 to determine what changes are best to remove the microplastic, e.g., move the microplastics to the discharge tube 118.

In some implementations, a location of detected microplastics affects a control signal provided by the control unit 110. For example, the control unit 110 can determine, using a location of a detected microplastic particle, where one or more removal devices direct their effects or which of one or more removal devices are activated. In one case, if the control unit 110 determines that microplastic particles are in a lower portion of an image captured by the camera 108, the control unit 110 can send a control signal to the acoustic transducers 114a-d to vibrate more strongly and a control signal to the acoustic transducers 112a-d to vibrate comparatively less strongly. In this way, the microplastics can be shifted within a body of water, e.g., towards a discharge tube 118.

The acoustic transducers 112a-d and 114a-d generate pressure waves which cause microplastics in the water 104 to move. The camera 116 captures images similar to the camera 108. In some implementations, the camera 116 obtains one or more images and provides the one or more images to the control unit 110 as feedback data. For example, the control unit 110 can determine, using the feedback data from the camera 116, whether or not to generate and transmit control signals to the acoustic transducers 112a-d and 114a-d to adjust pressure waves generated by the acoustic transducers 112a-d and 114a-d.

In some implementations, the control unit 110 provides data from images obtained by the camera 116 to a machine learning model. For example, the machine learning model can be trained to determine one or more adjustments to removal devices, such as the acoustic transducers 112a-d and 114a-d, using a detection of one or more microplastics in images captured by the camera 116.

In some implementations, the control unit 110 detects microplastics from one or more images captured by the camera 116 and provides data representing the detections to a trained machine learning model. For example, the trained machine learning model can include a microplastic detection step or can obtain data representing pre-detected microplastic particles from the control unit 110 as input data.

In some implementations, the system 100 trains a machine learning model to adjust one or more removal devices. For example, the water 104 can include one or more microplastic particles. The control unit 110 can provide one or more control signals to the acoustic transducers 112a-d and 114a-d to cause the acoustic transducers 112a-d and 114a-d to vibrate and cause microplastics in the water 104 to move. The control unit 110 can compare images obtained from the camera 116 to one or more ground truth images, e.g., programed by a user or provided based on user feedback after user review of images, or ground truth features, e.g., majority of microplastics in a particular region of an image corresponding to a location of the discharge tube 118.

A ground truth image can include microplastics in a correct region for flowing into the discharge tube 118. A ground truth image can be generated by manually tuning and controlling the acoustic transducers 112a-d and 114a-d to move microplastics into the discharge tube 118 and capturing images from the camera 116 as the microplastics are moved and flowing into the discharge tube 118.

In some implementations, detecting one or more microplastic particles that satisfy a distance threshold from the camera 116 cause the control unit 110 to adjust control signals to the acoustic transducers 112a-d and 114a-d. For example, the control unit 110 can detect microplastics in the water 104 that exceed a threshold distance from the camera 116 and are therefore not flowing into the discharge tube 118 but will flow to a returning tube 120 back to the water source 102. The thresholds can depend on a location of the camera 116 and a target location for microplastic particles, e.g., the discharge tube 118.

In some implementations, if the control unit 110 detects microplastics too far away, e.g., exceeding a distance threshold, the control unit 110 generates a control signal to adjust one or more of the acoustic transducers 112a-d and 114a-d. For example, the control unit 110 can generate a signal and transmit the signal to the acoustic transducers 114a-d to increase a pressure wave intensity or frequency to increase an upward movement of microplastics. This can have an effect of reducing a distance of microplastics to the camera 116 and causing the microplastics to flow into the discharge tube 118.

In some implementations, the control unit 110 detects an object of a type to be sent back to the water source 102. For example, to help avoid jams or clogs in the discharge tube 118 or post processing 119, the control unit 110 can detect larger objects or non-plastic objects and ensure that the removing devices move those objects to the return tube 120 to be returned to the water source 102 and not damage or disable the discharge tube 118 or elements of post processing 119.

In some implementations, the system 100 directs microplastics through a discharge tube 118 for post processing 119. For example, post processing 119 can include recycling microplastics removed from the water 104, disposing of the microplastics, storing them for later use, among others. In some implementations, the discharge tube 118 includes one or more filters, e.g., filter 117. Filtered water can be transferred back to the water source 102 using pipe 121.

In some implementations, the system 100 directs purified water, with microplastics having been removed, to the returning tube 120. For example, the system 100 can direct microplastics to a first location and purified water to a second location. The second location can be a pipe, such as the returning tube 120, that returns the purified water back to the water source 102. In this way, the system 100 can cycle through water in the water source 102 to gradually remove microplastics from the water source 102.

In some implementations, the control unit 110 detects microplastics in images from the camera 108. If the control unit 110 detects microplastics below a threshold value over a determined period of time, the control unit 110 can determine that the water source 102, or a current portion of the water source 102 is free, or sufficiently free, from microplastics. The control unit 110 can provide a signal indicating the lack of microplastic particles to a user device or directly move the system 100 to another location. The system 100 can periodically process water to determine if a new location has microplastics to be removed.

In some implementations, instead of, or in addition to, acoustic transducers, the system 100 can include air or bubble generation devices. For example, one or more of the acoustic transducers 112a-d and 114a-d can be replaced with air or bubble generation devices that receive control signals from the control unit 110 to generate air or bubbles. Similar to the pressure waves caused by the acoustic transducers 112a-d and 114a-d that move the microplastics to the discharge tube 118, air or bubbles, e.g., generated by air or bubble generation devices, can move the microplastics. Air or bubble generation devices or other suitable removal devices can be used in the physical removal system of the system 100.

In some implementations, the system 100 includes more or fewer elements in any of the camera system, a lighting system, or the physical removal system. For example, instead of 8 acoustic transducers, the system 100 can include 4, 2, or another number of acoustic transducers. Instead of two cameras, the system 100 can include another number of cameras, e.g., one. In some implementations, a camera, such as the camera 116, is placed before one or more acoustic transducers. For example, a single camera can be placed before one or more acoustic transducers, or other removal devices, and after one or more acoustic transducers to provide feedback on the effect of a given removal device. In this way, cost of a system can be reduced while maintaining accuracy.

In some implementations, the pipe 103 is shaped differently than shown in FIG. 1. For example, the pipe 103 can resemble a chamber. In some implementations, the pipe 103 is not without of the water source 102 but submerged in the water source 102 or below a water line of the source 102. In some implementations, the pipe 103 is located inland from a water source. In some implementations, the pipe 103 is connected to a barge that floats on the water source 102. In some implementations, the acoustic transducers are above a water line. For example, both the acoustic transducers 112a-d and 114a-d and the pipe 103 can be above the water source 102.

In some implementations, acoustic transducers vibrate at a frequency or intensity that may have the potential of harming marine life. The system 100 can include acoustic damping mechanisms to help prevent vibrations from acoustic transducers from reaching marine life. In some implementations, the transducers 112a-d and 114a-d and the pipe 103 are located above the water source 102 to help isolate the transducers 112a-d and 114a-d and prevent harm or other disruptions to marine life.

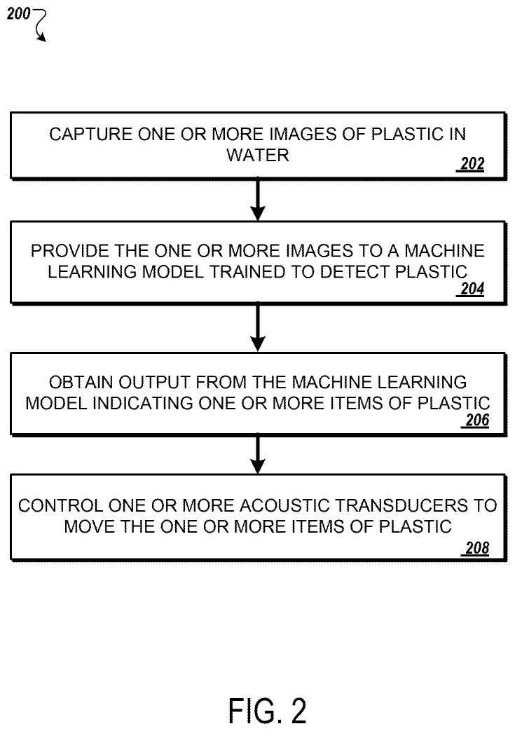

FIG. 2 is a flow diagram illustrating an example of a process 200 for removing microplastics. The process 200 may be performed by one or more electronic systems, for example, the system 100 of FIG. 1 or the control unit 110.

The process 200 includes capturing one or more images of plastic in water (202). For example, the camera 108 captures one or more images of plastic in the water 104. In some implementations, the control unit 110 controls the camera 108 to capture one or more images. In some implementations, the control unit 110 controls the lights 109a-b to emit light, of one or more frequencies, to corresponding with a capturing of an image such that a captured image is illuminated by later from one or more of the lights 109a-b.

The process 200 includes providing the one or more images to a machine learning model trained to detect plastic (204). For example, the control unit 110 can obtain images captured from the camera 108 and provide the one or more images to a model trained to detect plastics. The model can be trained to provide output to the control unit 110 indicating one or more detections. Detections can include a size, type, shape, or other features of detected plastic. The detections can be used by the control unit 110 to generate or send control signals to one or more removing devices, such as the acoustic transducers 112a-d and 114a-d.

The process 200 includes obtaining output from the machine learning model indicating one or more items of plastic (206). For example, the control unit 110 can obtain output from a trained model indicating a location, type, or size of one or more microplastic particles.

The process 200 includes controlling one or more acoustic transducers to move the one or more items of plastic (208). For example, the control unit 110 can use detections obtained by a trained model to generate and provide control signals to the acoustic transducers 112a-d and 114a-d. The control signals can cause the acoustic transducers 112a-d and 114a-d to vibrate at a particular frequency or intensity.

Where removing devices are not acoustic transducers but are air generation devices (e.g., devices that blow air or make bubbles to move the plastic instead of pressure waves emitted by the acoustic transducers), the control unit 110 can generate and provide control signals to cause the removing devices to generate air or air bubbles at a particular rate or of a particular size.

A sonic wave, or pressure wave, such as those generated by the transducers 112a-d and 114a-d, can include vibrations transmitted through a medium such as air, water, or metal. Sonic waves can be created by a transducer, such as a speaker. In some implementations, the system 100 uses the transducers 112a-d and 114a-d to focus a transmission of sonic waves through liquid solutions to remove one or more items of plastic.

In some implementations, the system 100 operates according to one or more constraints. For example, vibrations can be measured by their frequency and water can carry frequencies in the 10 Hz to 1 MHz range. Water environments can be more difficult than air because water can change salinity, temperature, and liquid composition. Such changes can radically change the type of pressure waves that are needed to move small objects, such as pieces of plastic, precisely.

In some implementations, the system 100 guides water past a series of screens to prevent larger aquatic life from entering but allowing microplastic particles to pass through. The screens can range in size, e.g., 1-2 cm mesh size. Filtered water can pass slowly, actively, or passively, through a chamber or tube, such as the pipe 103, where a sonic pressure wave is generated, e.g., by one or more of the transducers 112a-d and 114a-d, and travels at least partially perpendicular to the flow of sea water. The system 100 and the transducers 112a-d and 114a-d can generate one or more sonic waves to aggregate plastic particles, such as microplastics, toward a fine mesh screen, e.g., 1 mm mesh size, where the aggregated microplastic will build up against the screen. In some implementations, a mesh screen is included in the discharge tube 118. In some implementations, the pipe 103 includes one or more additional discharge tubes with additional filter sizes. In some implementations, the pipe 103 includes one or more additional discharge tubes that are each used to remove a specific type of plastic.

In some implementations, a filter screen used to filter plastic is mechanically cleared or replaced once the system 100 determines a threshold amount of microplastic has been collected. An advantage of this approach over only using mesh filters is that sea life that is the same size as microplastics (e.g., algae) can safely exit the filters. In some cases, sea life is not affected by sonic waves generated by the transducers 112a-d and 114a-d in the same way items of plastic are. For example, differences in rigidity or other structural properties can allow sonic waves to affect a travel path of plastics different than a travel path of marine life.

In some implementations, an aqueous solution flows through the pipe 103. The pipe 103 can be a chamber, holding cell, or any suitable type of containing element. An aqueous solution can come directly from a river, a factory, or an aquaculture facility. Plastic detectors, such as the camera 108, can detect a presence and location of plastics in the liquid. In some implementations, the system 100 includes other types of plastic detectors. For example, plastic detectors can be devices that do not use captured images.

Plastic detectors used by the system 100 can include infrared spectrometers, hyperspectral cameras, polarized light cameras, among others. One or more plastic detectors of the system 100 can be able to establish a type of plastic (e.g., Polycarbonate, Polyethylene, among others). A given plastic detector can send instructions, e.g., to the control unit 110, to control the transducers 112a-d and 114a-d to send a pulse that directs plastic towards a collection chamber, such as the discharge tube 118, or one or more other discharge tubes similar to the discharge tube 118 for specific categories of plastic.

In some implementations, the system 100 includes a sensor in a collection chamber. For example, the system 100 can include a sensor in the discharge tube 118 to detect an amount of plastic that flowed into the discharge tube 118 or an amount of plastic that is filtered by the filter 117, e.g., a weight sensed on a screen of the filter 117 monitored by the control unit 110 or connected component over time.

In some implementations, if the system 100 determines that a collection chamber is holding or has removed a threshold amount of plastic compared to an expected amount, e.g., an amount expected based on detections of plastic and control movements configured by the transducers 112a-d and 114a-d and the control unit 110, the control unit 110 determines that a re-calibration is required. For example, the amount detected in the discharge tube 118 can be below a threshold amount expected based on plastic detections using plastic detectors of the system 100. The fact that the amount was not detected indicates that the sonic waves generated by the transducers 112a-d and 114a-d and the control unit 110 are not sufficient and new propagation parameters should be used.

In some implementations, the control unit 110 scans over a range of propagation parameters that control a propagation of waves generated by the transducers 112a-d and 114a-d. For example, the control unit 110 can adjust propagation parameters until an amount of expected plastic at a discharge location matches an expected amount.

In some implementations, the system 100 is calibrated by putting known plastics in the water 104. The control unit 110 can detect for the known plastics and ensure the pieces end up where expected, e.g., at one or more specified removal locations. The system can re-calibrate itself depending on properties of the liquid. In some implementations, the control unit 110 can continuously adjust propagation parameters and monitor discharge locations and compare to expected plastic amounts to determine if, or how, to adjust propagation parameters.

In some implementations, plastic detectors of the system 100 detect marine life in the water 104. If the system 100 detects a species that is sensitive to audio frequencies, the control unit 110 can pause frequencies, or choose frequencies outside the animal's hearing range, at least until the animal moves outside a threshold a distance from the system 100 or is outside of the pipe 103.

In some implementations, sonic vibrations are able to move pieces of plastic in an aqueous solution by forcing the liquid to push pieces in certain directions. The vibrations can be created by one or more transducers, such as the transducers 112a-d and 114a-d. In some implementations, the transducers 112a-d and 114a-d are capable of creating several different frequencies underwater.

In some implementations, the water 104 is a combination of water and other components. For example, the water 104 can be a medicinal solution, e.g., a solution that helps treat marine life in an aquaculture environment. In general, ocean water includes many other nutrients and chemicals besides hydrogen and oxygen (e.g., H₂O).

Some ocean animals grow in substances that may not be generally considered water, e.g., mussels on partially submerged rocks, oyster in mud, fish in algae ponds, among others.

In some implementations, the system 100 for removing microplastics removes plastic from the water 104 based on type and effectively sorts different plastics. For example, the system 100 can detect plastic of different types and move the different types of plastic to different discharge locations, similar to the discharge tube 118. The system 100 can precisely detect and pinpoint different pieces and then move those pieces in a controlled way, e.g., it can separate one or more types of plastic. The system 100 can physically separate plastics into different categories, e.g., for research or recycling purposes, such as microfibers, Acrylic or Polymethyl Methacrylate (PMMA), Polycarbonate (PC), Polyethylene (PE), Polypropylene (PP), Polyethylene Terephthalate (PETE or PET), Polyvinyl Chloride (PVC), Acrylonitrile-Butadiene-Styrene (ABS)

In some implementations, the system 100 for removing microplastics is used to recycle plastic. For example, the system 100 can gather plastics, sort the plastics into types, and provide the different types of plastics to respective recycling processes for recycling the corresponding type of plastic.

FIG. 3 is a diagram showing computing devices for removing microplastics. FIG. 3 is a block diagram of computing devices 300, 350 that may be used to implement the systems and methods described in this specification, as either a client or as a server or plurality of servers. Computing device 300 is intended to represent various forms of digital computers, such as laptops, desktops, workstations, personal digital assistants, servers, blade servers, mainframes, and other appropriate computers. Computing device 350 is intended to represent various forms of mobile devices, such as personal digital assistants, cellular telephones, smartphones, smartwatches, head-worn devices, and other similar computing devices. The components shown here, their connections and relationships, and their functions, are meant to be exemplary only, and are not meant to limit implementations described and/or claimed in this specification.

Computing device 300 includes a processor 302, memory 304, a storage device 306, a high-speed interface 308 connecting to memory 304 and high-speed expansion ports 310, and a low speed interface 312 connecting to low speed bus 314 and storage device 306. Each of the components 302, 304, 306, 308, 310, and 312, are interconnected using various busses, and may be mounted on a common motherboard or in other manners as appropriate. The processor 302 can process instructions for execution within the computing device 300, including instructions stored in the memory 304 or on the storage device 306 to display graphical information for a GUI on an external input/output device, such as display 316 coupled to high speed interface 308. In other implementations, multiple processors and/or multiple buses may be used, as appropriate, along with multiple memories and types of memory. Also, multiple computing devices 300 may be connected, with each device providing portions of the necessary operations (e.g., as a server bank, a group of blade servers, or a multi-processor system).

The memory 304 stores information within the computing device 300. In one implementation, the memory 304 is a computer-readable medium. In one implementation, the memory 304 is a volatile memory unit or units. In another implementation, the memory 304 is a non-volatile memory unit or units.

The storage device 306 is capable of providing mass storage for the computing device 300. In one implementation, the storage device 306 is a computer-readable medium. In various different implementations, the storage device 306 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 304, the storage device 306, or memory on processor 302.

The high speed controller 308 manages bandwidth-intensive operations for the computing device 300, while the low speed controller 312 manages lower bandwidth-intensive operations. Such allocation of duties is exemplary only. In one implementation, the high-speed controller 308 is coupled to memory 304, display 316 (e.g., through a graphics processor or accelerator), and to high-speed expansion ports 310, which may accept various expansion cards (not shown). In the implementation, low-speed controller 312 is coupled to storage device 306 and low-speed expansion port 314. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 320, or multiple times in a group of such servers. It may also be implemented as part of a rack server system 324. In addition, it may be implemented in a personal computer such as a laptop computer 322. Alternatively, components from computing device 300 may be combined with other components in a mobile device (not shown), such as device 350. Each of such devices may contain one or more of computing device 300, 350, and an entire system may be made up of multiple computing devices 300, 350 communicating with each other.

Computing device 350 includes a processor 352, memory 364, an input/output device such as a display 354, a communication interface 366, and a transceiver 368, among other components. The device 350 may also be provided with a storage device, such as a microdrive or other device, to provide additional storage. Each of the components 350, 352, 364, 354, 366, and 368, are interconnected using various buses, and several of the components may be mounted on a common motherboard or in other manners as appropriate.

The processor 352 can process instructions for execution within the computing device 350, including instructions stored in the memory 364. The processor may also include separate analog and digital processors. The processor may provide, for example, for coordination of the other components of the device 350, such as control of user interfaces, applications run by device 350, and wireless communication by device 350.

Processor 352 may communicate with a user through control interface 358 and display interface 356 coupled to a display 354. The display 354 may be, for example, a TFT LCD display or an OLED display, or other appropriate display technology. The display interface 356 may comprise appropriate circuitry for driving the display 354 to present graphical and other information to a user. The control interface 358 may receive commands from a user and convert them for submission to the processor 352. In addition, an external interface 362 may be provided in communication with processor 352, so as to enable near area communication of device 350 with other devices. External interface 362 may provide, for example, for wired communication (e.g., via a docking procedure) or for wireless communication (e.g., via Bluetooth or other such technologies).

The memory 364 stores information within the computing device 350. In one implementation, the memory 364 is a computer-readable medium. In one implementation, the memory 364 is a volatile memory unit or units. In another implementation, the memory 364 is a non-volatile memory unit or units. Expansion memory 374 may also be provided and connected to device 350 through expansion interface 372, which may include, for example, a SIMM card interface. Such expansion memory 374 may provide extra storage space for device 350, or may also store applications or other information for device 350. Specifically, expansion memory 374 may include instructions to carry out or supplement the processes described above, and may include secure information also. Thus, for example, expansion memory 374 may be provided as a security module for device 350, and may be programmed with instructions that permit secure use of device 350. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 364, expansion memory 374, or memory on processor 352.

Device 350 may communicate wirelessly through communication interface 366, which may include digital signal processing circuitry where necessary. Communication interface 366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 368. In addition, short-range communication may occur, such as using a Bluetooth, WiFi, or other such transceiver (not shown). In addition, GPS receiver module 370 may provide additional wireless data to device 350, which may be used as appropriate by applications running on device 350.

Device 350 may also communicate audibly using audio codec 360, which may receive spoken information from a user and convert it to usable digital information. Audio codec 360 may likewise generate audible sound for a user, such as through a speaker, e.g., in a handset of device 350. Such sound may include sound from voice telephone calls, may include recorded sound (e.g., voice messages, music files, etc.) and may also include sound generated by applications operating on device 350.

The computing device 350 may be implemented in a number of different forms, as shown in the figure. For example, it may be implemented as a cellular telephone 380. It may also be implemented as part of a smartphone 382, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

What is claimed is:

1. A method comprising:
obtaining one or more images of plastic in water;
providing the one or more images to a machine learning model trained to detect plastic;
obtaining output from the machine learning model indicating one or more items of plastic; and
controlling one or more acoustic transducers to move the one or more items of plastic using the output from the machine learning model.

2. The method of claim 1, wherein the output from the machine learning model comprises:
a location of each of the one or more items of plastic.

3. The method of claim 1, wherein the output from the machine learning model comprises:
a value indicating a quantity of the one or more items of plastic.

4. The method of claim 1, comprising:
providing data representing the one or more images of plastic in water as input data to control one or more plastic processing stages.

5. The method of claim 1, comprising:
controlling the one or more acoustic transducers to move the one or more items of plastic to one or more plastic processing stages configured to process plastic.

6. The method of claim 1, wherein the one or more acoustic transducers are configured along a system connected to a water source.

7. The method of claim 1, comprising:
controlling a first light of a first color to illuminate;
controlling a camera to capture a first image of the one or more images while the first light is illuminated;
controlling a second light of a second color to illuminate; and
controlling the camera to capture a second image of the one or more images while the second light is illuminated.

8. The method of claim 1, comprising:
controlling the one or more acoustic transducers to move the one or more items of plastic within a vessel, wherein the vessel is connected to a water source at a first location and a second location and the vessel is configured to obtain the water that includes the one or more items of plastic from the first location and provide the water without the one or more items of plastic to the second location.

9. The method of claim 8, wherein the first location and the second location are the same location.

10. The method of claim 8, wherein the vessel is within the water source.

11. The method of claim 1, wherein obtaining the one or more images of plastic in water comprises:
controlling a camera to capture the one or more images of plastic.

12. The method of claim 1, comprising:
detecting a first type of plastic using the one or more images of plastic in water;
detecting a second type of plastic using the one or more images of plastic in water;
controlling the one or more acoustic transducers to move one or more items of the first type of plastic to a first location; and
controlling the one or more acoustic transducers to move one or more items of the second type of plastic to a second location.

13. A system comprising:
one or more computers and one or more storage devices storing instructions that are operable, when executed by the one or more computers, to cause the one or more computers to perform operations comprising:
obtaining one or more images of plastic in water;
providing the one or more images to a machine learning model trained to detect plastic;
obtaining output from the machine learning model indicating one or more items of plastic; and
controlling one or more acoustic transducers to move the one or more items of plastic using the output from the machine learning model.

14. The system of claim 13, wherein the output from the machine learning model comprises:
a location of each of the one or more items of plastic.

15. The system of claim 13, wherein the output from the machine learning model comprises:
a value indicating a quantity of the one or more items of plastic.

16. The system of claim 13, wherein the operations comprise:
providing data representing the one or more images of plastic in water as input data to control one or more plastic processing stages.

17. The system of claim 13, wherein the operations comprise:
controlling the one or more acoustic transducers to move the one or more items of plastic to one or more plastic processing stages configured to process plastic.

18. The system of claim 13, wherein the one or more acoustic transducers are configured along a system connected to a water source.

19. The system of claim 13, wherein the operations comprise:
controlling a first light of a first color to illuminate;
controlling a camera to capture a first image of the one or more images while the first light is illuminated;
controlling a second light of a second color to illuminate; and
controlling the camera to capture a second image of the one or more images while the second light is illuminated.

20. A non-transitory computer-readable medium storing software comprising instructions executable by one or more computers which, upon such execution, cause the one or more computers to perform operations comprising:
obtaining one or more images of plastic in water;
providing the one or more images to a machine learning model trained to detect plastic;
obtaining output from the machine learning model indicating one or more items of plastic; and
controlling one or more acoustic transducers to move the one or more items of plastic using the output from the machine learning model.
